(19) United States
(12) Patent Application Publication
(10) Pub. No.: US 2026/0350963 A1
(43) Pub. Date: Nov. 5, 2026

(54) METHOD AND SYSTEM FOR DETERMINING AN OBJECT STRUCTURE OF AN OBJECT, CONTROL DEVICE FOR A SYSTEM

(71) Applicants: CARIAD SE, Wolfsburg (DE); ROBERT BOSCH GMBH, Stuttgart (DE)

(72) Inventor: Dominik STÖSSER, Bollendorf (DE)

(21) Appl. No.: 19/482,694

(22) PCT Filed: May 6, 2024
(86) PCT No.: PCT/EP2024/062460

§ 371 Date: Nov. 7, 2025

(30) Foreign Application Priority Data
May 10, 2023 (DE) 10 2023 112 303.3

(51) Int. Cl. G06V 10/44; G06V 10/774; G06V 10/82

(52) U.S. Cl. CPC G06V 10/457; G06V 10/774; G06V 10/82

(57) ABSTRACT

A method for determining an object structure of an object is provided. First, image data describing an image of an environment with the object located therein and are received from at least one sensor device. This image data is then fed into at least one neural network. The at least one neural network is trained to determine feature data, including predetermined features with respect to basic geometric shapes and/or colors of the object. Edge end points of the object structure of the object are determined by using an edge end point determiner. At the same time, edge intermediate points of the object structure are determined by using an edge intermediate point determiner. The determined edge end points and edge intermediate points are used to determine and/or mark the final object structure. The determined object structure is then provided for a computer vision function.

### BACKGROUND

### Technical Field

The disclosure relates to a method for determining an object structure of an object, comprising the steps: providing image data, which describes an image of an environment with the object located therein and which has been received from at least one sensor device; and feeding the image data into at least one neural network, which is trained to determine feature data, wherein the feature data includes predetermined features with respect to basic geometric shapes and/or colors of the object.

### Description of the Related Art

The object recognition is a partial area of image processing, in which one attempts to identify individual objects in images. For example, a traffic island and/or a lane marking and/or a lane edge and/or a further vehicle can be meant with the term “object”. Conventional methods, such as for example using bounding boxes or line recognition, are restricted in their function to the effect that only objects of certain shape can be determined. In order to ensure a configuration of such an object recognition as advantageous as possible, it is accordingly desirable that an object or an object structure or a center line of an object of any shape is determined. Herein, the basic shape and/or the composition of the optical appearance of the object are meant with “object structure”.

A system for object recognition, which is specifically designed for the recognition of lanes, usually only considers highway scenarios, in which lane markings and road edges can be described by straight lines. However, such an object recognition system for example fails in city scenarios, where objects such as for example lane edges and/or traffic islands can have any geometric shape, such as a polyline shape. An open or closed sequence of contiguous line and/or arc segments is referred to as polyline shape or polyline.

The publication “CondLaneNet: a Top-to-down Lane Detection Framework Based on Conditional Convolution” (Authors: Liu, Lizhe & Chen, Xiaohao & Zhu, Siyu & Tan, Ping. Published: 2021) discloses a method for determining lane lines, which appear vertically in images. Since it is a method based on line anchors, polylines or object structures of any shape cannot be recognized.

The publication “A Keypoint-based Global Association Network for Lane Detection” (Authors: Wang, Jinsheng & Ma, Yinchao & Huang, Shaofei & Hui, Tianrui & Wang, Fei & Qian, Chen & Zhang, Tianzhu. Published: 2022) discloses a method for determining lane lines, wherein the lane lines are determined by a global association of marked end points of lines.

The publication “RCLane: Relay Chain Prediction for Lane Detection” (Authors: Xu, Shenghua & Cai, Xinyue & Zhao, Bin & Zhang, Li & Xu, Hang & Fu, Yanwei & Xue, Xiangyang. Published: 2022) discloses a method for determining lane lines, wherein a global distance formulation is used, which only works for straight lane lines.

No possibility of determining object structures of objects of any shape results from the prior art.

### BRIEF SUMMARY

Embodiments of the present disclosure recognize an object structure of an object based on image data in an environment, in particular a road traffic environment.

By the disclosure, a method for determining an object structure of an object is provided. For example, the method can be used as a constituent of a computer vision functionality to recognize, in a motor vehicle, an object in an environment of the motor vehicle with respect to its object structure. Based on the recognized object structure, e.g., a driving trajectory for bypassing the object can be calculated. The method comprises the following steps: Image data, which describes an image of an environment with the object located therein, is received and provided from at least one sensor device. The image data is fed into at least one neural network, which is trained to determine feature data, wherein the feature data includes predetermined features with respect to the basic geometric shapes and/or colors of the object. Such features can, e.g., be horizontal and/or vertical lines and/or arcs, to mention just examples. The feature data is determined by way of a so-called backbone, wherein the backbone is configured as at least one artificial neural network, wherein the backbone for example includes at least one residual neural network and/or densely connected convolutional network pre-trained to predetermined features with respect to basic geometric shapes and/or colors of the object. Thus, the backbone can be additionally trained to data including polygonal shapes and/or structures. The feature data determined from the backbone is for example included or provided as a feature vector. In other words, the backbone is designed to receive image data or visual data from at least one sensor device and to determine and/or extract feature data therefrom. The at least one neural network can include a convolutional neural network.

From the backbone, a so-called feature map can be created. The backbone can include a plurality of convolutional layers, whereby the feature map includes a particularly large receptive field (such as the capture of 3*3 to 200*200 image elements), such that objects like traffic islands and/or lane edges can for example be determined as a whole.

According to the disclosure, two different image processing functionalities can now be connected downstream of the backbone in the at least one neural network, which can process the features from the feature map independently of each other.

The at least one neural network includes a so-called edge end point determiner on the one hand, which is designed to determine and/or mark edge end points and/or end points of the object structure of the object. Therein, the edge end points each mark a predetermined object end area (a line end) of the object. The feature data is subjected to a binary classification by way of the edge end point determiner, wherein the binary classification can include that feature vectors of the feature data are normalized and a normalized value, thus a classification value, above a predetermined threshold value is representative of having an edge end point of an object structure. By way of the edge end point determiner, a so-called seed point map can be created, wherein the seed point map comprises marked edge end points. For example, if a white lane arrow on a grey road underground is imaged in the image data, thus, as the edge end points, the two ends of the lane arrow (tip and opposing end) can be identified as edge end point. Hereto, the edge end point determiner can be trained to identify shapes, which have a size in a range from 20×20 cm to 75×75 cm and which end in a spatial direction or do not further extend in this direction. Thus, the object then ends in this direction and an edge end point can be set there. By way of the so-called seed point detection, thus, one-dimensional points (edge end points) are determined.

The at least one neural network includes an edge intermediate point determiner on the other hand, which is designed to determine and/or mark edge intermediate points and/or node points and/or connection points of the object structure on the feature data. The edge intermediate points mark line geometric shapes of the object, wherein a line geometric shape is a part of the object structure of the object. The line geometric shapes can be formed of straight lines and/or arcs and/or of a mixture of both and/or of polygonal surfaces.

The feature data is subjected to a further binary classification different from the first one by way of the edge intermediate point determiner, wherein this second binary classification can include that feature vectors of the feature data are normalized and a normalized value, thus a classification value, above a predetermined threshold value is representative of having line geometric shapes of an object structure. Furthermore, recognized edge intermediate points can additionally include so-called transition probabilities (thus probabilities between respective edge intermediate points adjacent in pairs). The transition probability can be exemplarily calculated as follows. For example, 0.9 is the classification probability, thus resulting from the second binary classification, for an edge intermediate point x and 0.75 is the classification probability for an edge intermediate point y (also resulting from the second binary classification), such that a transition probability between edge intermediate point x and edge intermediate point y, e.g., results by way of the following calculation: \sqrt{(0.9−1)²+(0.75−1)²}=0.269 and thereby 0.269 is the transition probability between edge intermediate point x and y. Therein, the calculation of the transition probability can also be effected without subtraction, thus, e.g., as follows \sqrt{(0.9)²+(0.75)²}. This transition probability can then be used for a graph search criterion, which is introduced below. Thus, the edge intermediate point determiner can be configured to calculate (generate) these transition probabilities. By way of the edge intermediate point determiner, a topology map can be created, which comprises edge intermediate points of the object structure. A graph can be indicated on the topology map by the marked edge intermediate points.

Thus, the feature vectors are preferably respectively subjected to a binary classification, wherein the feature vectors include parameterizable (numeric) characteristics of a geometric shape and/or a pattern of the object in vectorial manner. Different features characteristic of the pattern can form different dimensions of the feature vectors. Based on the feature vectors, thus, the following binary classification can be facilitated since they severely reduce the characteristics to be classified (for example, only one feature vector of ten numbers has to be considered instead of a complete image). In the above example of the lane arrow, individual line segments or line sections of the boundary line, which is formed by the transition from white lane arrow and grey road underground, can, e.g., be respectively identified as the edge intermediate point. Hereto, the edge intermediate point determiner can be trained to respectively signal sections or segments measured with a length in a range from 20 cm to 75 cm, which belong to a continuous line extending in two directions in the environment, as edge intermediate point.

The determination of the edge end points of the object structure as well as the determination of the edge intermediate points are performed independently of each other. The edge end point determiner and/or the edge intermediate point determiner can be included as a sub-network and/or as at least one layer of the at least one neural network.

The seed point map and the topology map can then be combined or merged. A seed point graph map can be created therefrom, wherein it comprises the marked edge end points and the marked edge intermediate points.

The object structure is determined by way of the edge end points and the edge intermediate points, e.g., by the at least one neural network or a downstream software in that the edge intermediate points, which are closest to a respective edge end point, are marked as contour end points of the object structure and at least two contour end points are respectively connected via edge intermediate points respectively adjacent in pairs. The final object structure of the object results therefrom.

In other words, the edge end points are interpreted as contour end points of the object structure. The determined object structure is then provided for a computer vision function. For example, the computer vision function can be encompassed in a motor vehicle as a parking assist and/or reversing system and/or lane recognition system and/or lane change assistance system. Furthermore, the disclosure can be used for autonomously driving in that a longitudinal and transverse guidance of the motor vehicle is performed by way of the determined object structure. By the disclosure, the advantage arises that the object structure to be determined can include any geometric shapes, because the object structure is not described as a bounding box of a surface of the object, but composed of edge intermediate points, which string together to the (arbitrarily shaped) object structure in the image data.

Developments, by which additional advantages arise, also belong to the disclosure.

A development provides that at least two contour end points are connected via the edge intermediate points by way of a graph search criterion, and line segments (paths) are generated as a result thereof. The graph search criterion can be a graph algorithm, wherein the graph algorithm can in particular be a Dijkstra algorithm. By way of the Dijkstra algorithm, a shortest and/or most inexpensive line segment between two contour end points via edge intermediate points adjacent in pairs is calculated and/or marked.

A development provides that the line segments include a cost value and the cost value is calculated by way of the graph search criterion. The cost value of a line segment results from the transition probabilities of the contour end points and the edge intermediate points, wherein the cost value is included, e.g., as a product or dot product of them. In other words, the cost value of a line segment results, wherein a line segment includes respectively at least two contour end points via edge intermediate points adjacent in pairs, from the transition probabilities of the contour end points and edge intermediate points, which are included in the line segment. A line segment, which, e.g., has a cost value of 0.16, is “more inexpensive” in terms of an optimization algorithm than a line segment, which has a cost value of 0.8.

A development provides that line segments, which have a cost value above a predetermined threshold value, are deleted by way of a deletion criterion, and thereby line segments remain, which indicate the object structure of the object. Thereby, the advantage arises that duplicated or replicated line segments are deleted. The deletion criterion can be configured, e.g., as a non-maximum suppression technique.

A development provides that the at least two contour end points are connected via edge intermediate points adjacent in pairs, wherein the connection is effected via respective transitions, wherein a transition for example includes a transition line, wherein transitions include a predefined number of distance values (distortion values) or regression values with respect to local curvature, which cause a positional shift in generating the line segments to avoid overfitting of the line segments to be generated to the contour end points and/or to the edge intermediate points. A predefined number of distance values thus defines an orthogonal distance or a compensation quantity of the line segments to be generated. With positional shift, a shift of the line segment in a three-dimensional image can for example be meant, wherein a distance value is provided, e.g., in a coordinate system with three axes (X-axis, Y-axis and Z-axis) as the X-value, such that a shift of the line segment in the X-axis results. In other words, a dimensional shift or an orthogonal shift, e.g., in a two-or three-dimensional image of the line segment to be generated can result by the predefined number of distance values. The dimension or the number of the distance values results via the formula (F): c=k*(s+1), wherein k is the number of the neighborhoods (neighbor connections) of a contour end point and/or an edge intermediate point and s is a predefined number of offset sample values, which in particular provides a variable for a multi-dimensional scaling of the line segment to be generated, wherein the number of offset sample values indicates how the position of the contour end points and/or edge intermediate points and thereby the line segments to be generated are shifted. In other words, C is the number of distance values, which are located in a cell or an image element of the feature map. The offset sample value itself can be, e.g., a type of “placeholder” between actual position of the object structure and desired position of the line segment and is learned and inferred by the at least one neural network. The predefined number of offset sample values is a so-called hyper parameter for the at least one neural network. Thus, the predefined number of offset sample values s as well as the predefined neighbor connections k can regress the orthogonal shift by way of the number of the distance values c to be calculated by the formula F to an actual object structure, wherein each image element included by the object structure can include a regressed segment (line segment) of the actual object structure. Thus, the number of the distance values c can each provide support points for the resulting line segment. Therein, the number of the offset sample values s can be parameterized. Edge intermediate points and/or contour end points can include this predefined number of the distance values c such that a shift or local curvature of the line segment to be generated can result later, upon application of the graph search criterion.

A development provides that the feature data is determined by way of a self-attention technique. By way of the self-attention technique, a calculation complexity of the at least one neural network for determining the feature data can be reduced.

A development provides that the feature data is determined by way of a feature pyramid network technique. By way of the feature pyramid network technique, so-called low-level (local) and high-level (semantic) features can be more strongly connected.

A development provides that the at least one neural network is trained to determine the object structure of the object by way of a backpropagation, wherein training data is used, which has a label of the object structure. The at least one neural network is thus trained by way of supervised learning. In the backpropagation, an input such as for example image data, which is transformed into input vectors, is propagated through the at least one neural network. The output of the at least one neural network resulting therefrom is compared to the desired output. The difference of the two values is deemed an error of the neural network and the error is now again backpropagated via the output to the input layer. Therein, the weightings of the neural connections of the at least one neural network are changed depending on their influence on the error. Upon new application of the input, this guarantees an approximation to the desired output. By way of backpropagation, the at least one neural network can be corrected (improved). An optimization or improvement of the parameters of the at least one neural network can thus be performed. With the thus improved parameters of the at least one neural network, the at least one neural network is suitable in the application phase, to determine reasonable output vectors (outputs) from input vectors (inputs), which deviate from the originally learned input vectors of the training cases.

For application cases or application situations, which can arise in the method and which are not explicitly described here, it can be provided that an error message and/or a request for inputting a user feedback are output and/or a default setting and/or a predetermined initial state are adjusted according to the method.

The control device for a system also belongs to the disclosure. The control device can comprise a data processing device or a processor device, which is configured to perform an embodiment of the method according to the disclosure. Hereto, the processor device can comprise at least one microprocessor and/or at least one microcontroller and/or at least one FPGA (Field Programmable Gate Array) and/or at least one DSP (Digital Signal Processor). Furthermore, the processor device can comprise a program code, which comprises program instructions, which, upon execution by the processor device, cause it to perform a method according to any one of the preceding method claims. The program code can be stored in a data memory of the processor device. The processor device can be based, e.g., on at least one circuit board and/or on at least one SoC (System on Chip).

A system, which comprises the control device and at least one sensor device, also belongs to the disclosure. The system can perform the method according to the disclosure by way of the control device.

A motor vehicle, which comprises the system, also belongs to the disclosure. The motor vehicle according to the disclosure is preferably configured as an automobile, in particular as a passenger car or truck, or as a passenger bus or motorcycle.

As a further solution, the disclosure also includes a computer-readable storage medium including program code, which, upon execution by a computer or a computer cluster, causes it to execute an embodiment of the method according to the disclosure. The storage medium can be at least partially provided as a non-volatile data memory (e.g., as a flash memory and/or as an SSD solid state drive) and/or at least partially as a volatile data memory (e.g., as a RAM-random access memory). The storage medium can be arranged in the computer or computer cluster. However, the storage medium can for example also be operated as a so-called Appstore server and/or Cloud server in the Internet. By the computer or computer cluster, a processor circuit with for example at least one microprocessor can be provided. The program code can be provided as a binary code and/or as an assembler code and/or as a source code of a programming language (e.g., C) and/or as a program script (e.g., Python).

The disclosure also includes the combinations of the features of the described embodiments. Thus, the disclosure also includes realizations, which each comprise a combination of the features of multiple of the described embodiments, if the embodiments have not been described as mutually exclusive.

### BRIEF DESCRIPTION OF THE SEVERAL VIEWS OF THE DRAWINGS

In the following, execution examples of the disclosure are described.

FIG. 1 is an exemplary graphical representation, which illustrates features, which are associated with a method according to the present disclosure;

FIG. 2 is a flow diagram of an embodiment of the method according to the disclosure;

FIG. 3 is an exemplary graphical representation of a seed point map generated by an edge end point determiner according to an embodiment of the disclosure;

FIG. 4 is an exemplary graphical representation of a topology map generated by an edge intermediate point determiner according to an embodiment of the disclosure;

FIG. 5 is an exemplary graphical representation of intermediate points located in a square grid according to the disclosure, wherein a predefined number of offset sample values influences the orthogonal distance of a line segment to be generated;

FIG. 6 is an exemplary graphical representation for positional shift of a line segment by a number of offset sample values according to an embodiment of the disclosure;

FIG. 7 is an exemplary graphical representation of a most inexpensive path found by a graph search criterion in a graph according to an embodiment of the disclosure;

FIG. 8 is an exemplary graphical representation of marked line segments before application of a deletion criterion according to an embodiment of the disclosure; and

FIG. 9 is an exemplary graphical representation of lane markings and lane edges described by a polyline geometry according to an embodiment of the disclosure.

### DETAILED DESCRIPTION

The execution examples explained in the following are advantageous embodiments of the disclosure. In the execution examples, the described components of the embodiments each represent individual features of the disclosure to be considered independently of each other, which each also develop the disclosure independently of each other. Therefore, the disclosure also is to include combinations of the features of the embodiments different from the illustrated ones. Furthermore, the described embodiments can also be supplemented by further ones of the already described features of the disclosure.

In the figures, identical reference characters each denote functionally identical elements.

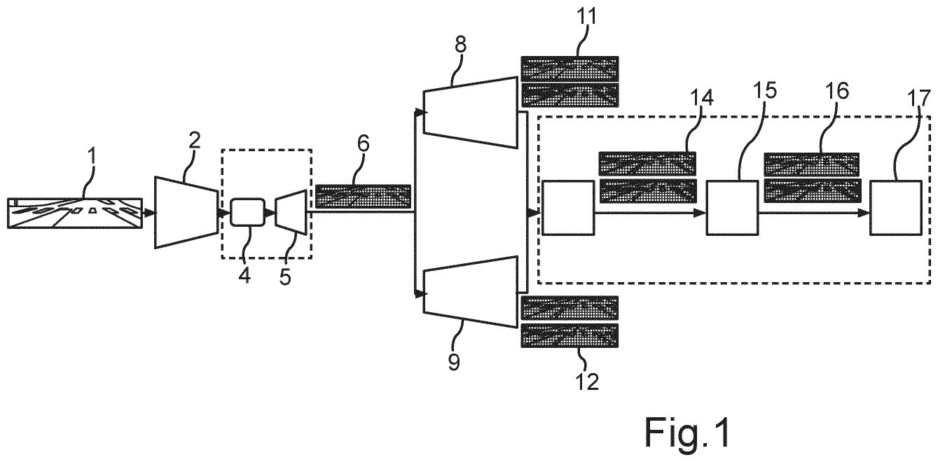

According to an embodiment, as FIG. 1 illustrates, image data 1 can be captured by way of at least one sensor device of the system, wherein the system is arranged in a motor vehicle. Herein, the image data 1 can for example describe a driving environment of the motor vehicle.

FIG. 1 shows that the at least one neural network can receive image data 1 from at least one sensor device of a system, wherein the image data 1 describes an environment. Thus, the image data 1 can be fed into the at least one neural network, wherein the at least one neural network includes a backbone 2 and this backbone 2 can be used for determining feature data. Additionally or alternatively, the at least one neural network can provide a self-attention technique 4 and/or a feature pyramid network technique 5. The backbone 2 and/or the self-attention technique 4 and/or the feature pyramid network technique 5 can in particular be trained to determine edges and/or line shapes and/or geometry points and/or vertices and/or ends of a line and/or ends of an object area. Moreover, the backbone 2—and/or the self-attention technique 4 and/or the feature pyramid network technique 5—can be trained to determine traffic islands and/or lane edges and/or lane markings. A so-called feature map 6 can be generated therefrom, wherein the feature map 6 can include feature data.

Then, the feature data can be subjected to a binary classification by way of an edge end point determiner 8, wherein the edge end point determiner 8 marks edge end points 18 in the image data 1. For example, the binary classification can include that the feature vectors are normalized and a normalized value, thus a classification value, above a predetermined threshold value is representative of having an edge end point 18 of an object structure. Furthermore, a binary classification can be performed by way of an edge intermediate point determiner 9 on the feature vectors. The feature data, which includes feature vectors, can each be normalized and feature vectors above a predetermined threshold value can have line geometric shapes of the object O, wherein the line geometric shapes can be marked based on the edge end point determiner 8. By way of the edge end point determiner 8, a so-called seed point map 11 can be created, wherein the seed point map 11 comprises marked edge end points 18.

By way of the edge intermediate point determiner 9, a topology map 12 can be created, which for example comprises edge intermediate points 19 of the object structure. The seed point map 11 and the topology map 12 can then be combined or merged. A seed point graph map 14 can be created therefrom, wherein it can comprise the marked edge end points 18 and the marked edge intermediate points 19. Subsequently, a graph search criterion 15 can be applied, wherein the graph search criterion 15 can calculate a most inexpensive path between two edge end points 18, where edge intermediate points 19 which are closest to a respective edge end point 18, can be marked as contour end points 20 of the object structure and each at least two contour end points 20 can be connected via edge intermediate points 19 adjacent in pairs, wherein line segments L can be generated as a result thereof.

After applying the graph search criterion 15, a so-called polyline map 16 can be created, wherein the polyline map 16 can comprise the line segments L generated by way of the graph search criterion 15. Finally, a so-called deletion criterion 17 can be applied, wherein the deletion criterion 17 can in particular be configured as a non-maximum suppression technique, which can delete one or more line segments L, which can have a cost value above a predetermined threshold value, and thereby one or more line segments L can remain, which can demonstrate the object structure of the object O. The object structure determined from the method according to the disclosure can then be used for a driver assistance function of a motor vehicle, such as for example a lane recognition and/or a parking assist.

The determination of the edge end points 18 by way of the edge end point determiner 8 can be effected by way of a cost function such as for instance the dissimilarity or similarity of gray values of pixels (image elements) of the image data 1 in a configuration. Therein, one can take that new pixel from a neighborhood, wherein in particular an eight-neighborhood can be meant with a neighborhood, which has the most similar gray value to the gray value of the start point of an edge end point 18. The recognition and/or marking of the edge end points 18 is aborted if either a certain surface of the object O is reached or if the similarity of the gray values is no longer given with respect to a threshold. Parameterless abortion criteria can also be applied, such as: at least one classification value with respect to a cost function can be associated with each pixel. For all edge end points 18 to the end of the previous object O, one can calculate the arithmetic mean of all costs K₁. Then, one can calculate the arithmetic mean of all costs K₂ for all neighbor pixels of the previous object O. For each newly included pixel, the cost difference |K₁−K₂| can be considered as a function of the number of the included pixels. This function can be calculated up to a certain maximum number of pixels. Now, the location of the function can be calculated as the abortion criterion, where it has its global maximum.

The edge intermediate point determiner 9 can be configured to create a so-called topology map 12, wherein the topology map 12 can include edge intermediate points 19 of the fed-in image data 1 marked by the edge intermediate point determiner 9.

For generating one or more line segments L by way of the Dijkstra algorithm, e.g., a square grid with an eight-neighborhood can be used, wherein an amount of pixels (image elements) or cells of the feature map can be given. A cost function can be calculated from the transition probabilities of the image elements. With respect to this cost function, a path with minimum costs can now be searched. Therein, it can be started from a first contour end point 20 and end in a preset second contour end point 20. The line segment L can be generated as soon as the second contour end point 20 is reached. Thus, image elements or marked contour end points 20 and/or edge intermediate points 19 can respectively include one or more transition probabilities (association) to adjacent image elements or marked edge intermediate points 19. This means that an image element or marked contour end point 20 and/or edge intermediate point 19 can include a transition probability to an image element to the right of the respective image element, a transition probability for an image element above the respective image element, etc., according to previous parametric setting. For example, it can be parametrically set if the diagonal neighbors of the respective image element are also to be considered (e.g., top right of the respective image element, top left of the respective image element, etc.).

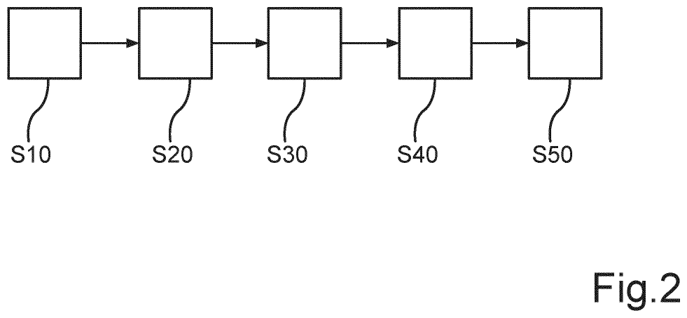

FIG. 2 represents in a method step S10, how image data 1, which describes an image of an environment with the object O located therein and which can be received from at least one sensor device. The image data 1 can be fed into the at least one neural network, wherein the at least one neural network can be trained to determine feature data, wherein the feature data can include predetermined features with respect to basic geometric shapes and/or colors of the object O. In a step S20, edge end points 18 of the object structure of the object O can be determined by applying an edge end point determiner 8 of the at least one neural network to the feature data, wherein edge end points 18 can each mark a predetermined object end area. In step S30, edge intermediate points 19 of the object structure can be determined by applying the edge intermediate point determiner 9 of the at least one neural network to the feature data, wherein edge intermediate points 19 can mark line geometric shapes of the object O, wherein a line geometric shape can be a part of the object structure of the object O. In step S40, the object structure can be determined by the at least one neural network by way of the edge end points 18 and the edge intermediate points 19, in that the edge intermediate points 19, which are closest to a respective edge end point 18, can be marked as contour end points 20 of the object structure and at least two contour end points 20 can respectively be connected via edge intermediate points 19 respectively adjacent in pairs. In step S50, the object structure can be provided for a computer vision function.

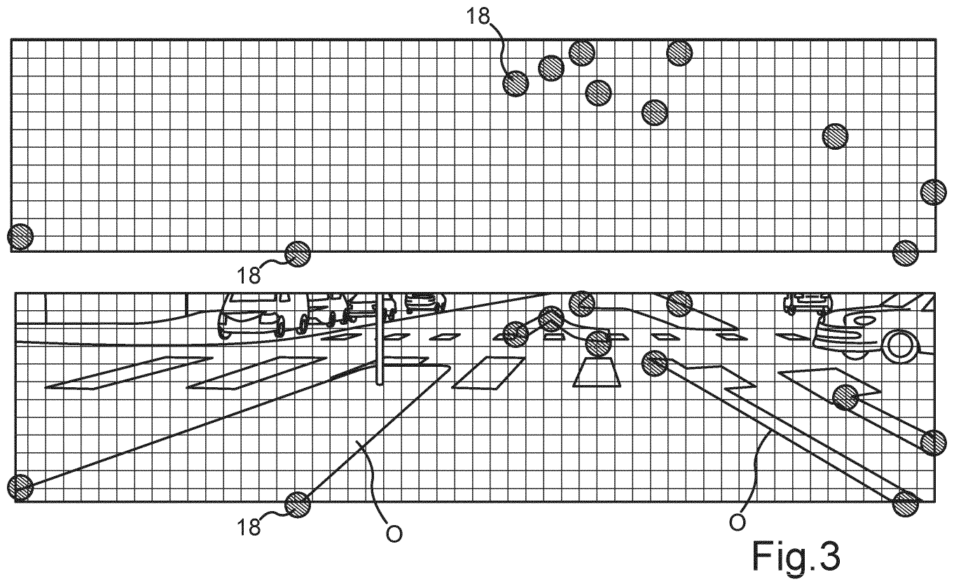

FIG. 3 shows an exemplary graphical representation of a seed point map. Edge end points 18 of the object structure can be marked by way of the edge end point determiner 8 on the seed point map. Herein, e.g., a tip and/or a line end of traffic islands or lane edges and lane markings could be interpreted as edge end points 18. Two edge end points 18 are exemplarily marked with the reference character. In this case, the at least one neural network can determine and/or mark traffic islands and lane markings, which are marked with the reference character O, since it is only trained thereto.

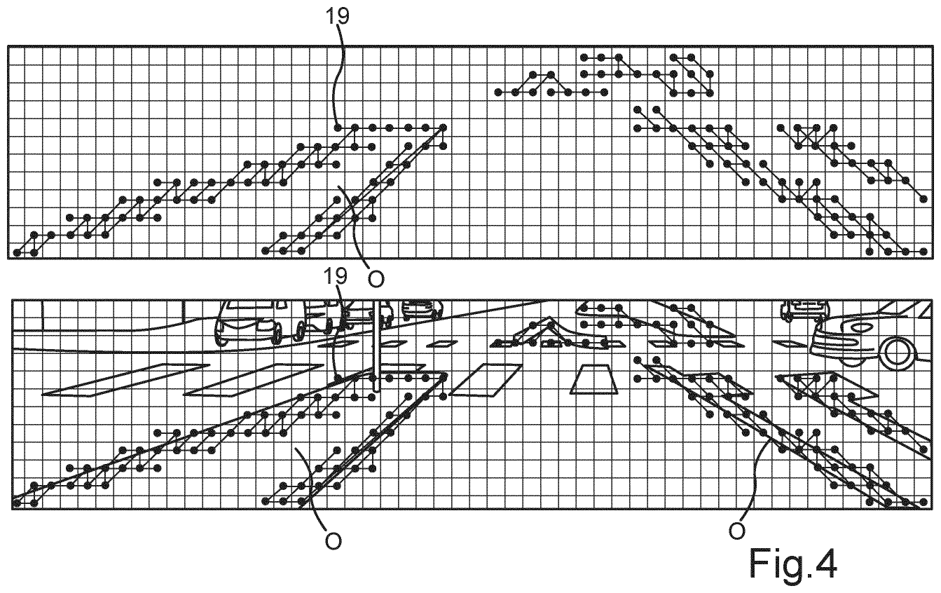

FIG. 4 shows the output of the edge intermediate point determiner 9, wherein the output is a so-called topology map 12. The marked edge intermediate points 19 are illustrated on respective line geometric shapes determined by the edge intermediate point determiner 8, wherein the edge intermediate points 19 can in particular mark image regions, which image a piece of a line. An edge intermediate point 19 is exemplarily provided with the reference character 19. Each edge intermediate point 19, which is recognized and/or marked, can be meant with this reference character. Edge intermediate points 19 can have one or more transition probabilities to an adjacent edge intermediate point 19 and/or neighbor, wherein the transition probability can be calculated and/or generated by way of the edge intermediate point determiner 8. FIG. 4, as well as FIG. 3, shows a generated square grid, wherein each image element or pixel can be exemplarily provided in an eight-neighborhood.

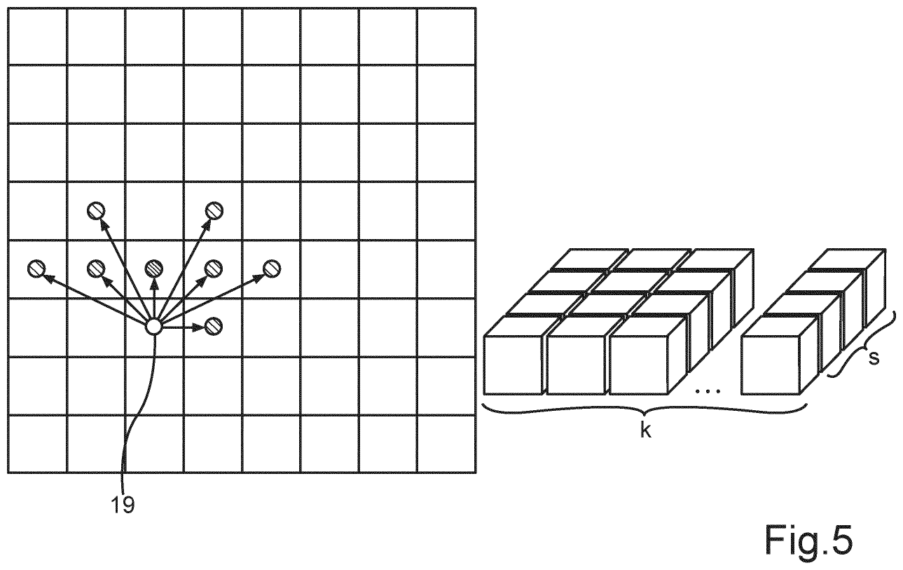

FIG. 5 shows that an edge intermediate point 19 can include a four-neighborhood (4-con) or an eight-neighborhood (8-con) or a sixteen-neighborhood (16-con). Herein, a predefined number of offset sample values s can be determined, wherein the number of offset sample values s can influence a number of the distance values c. Edge intermediate points 19 and/or contour end points 20 can include this number such that later, upon application of the graph search criterion 15, a shift or local curvature of the line segment L to be generated can result.

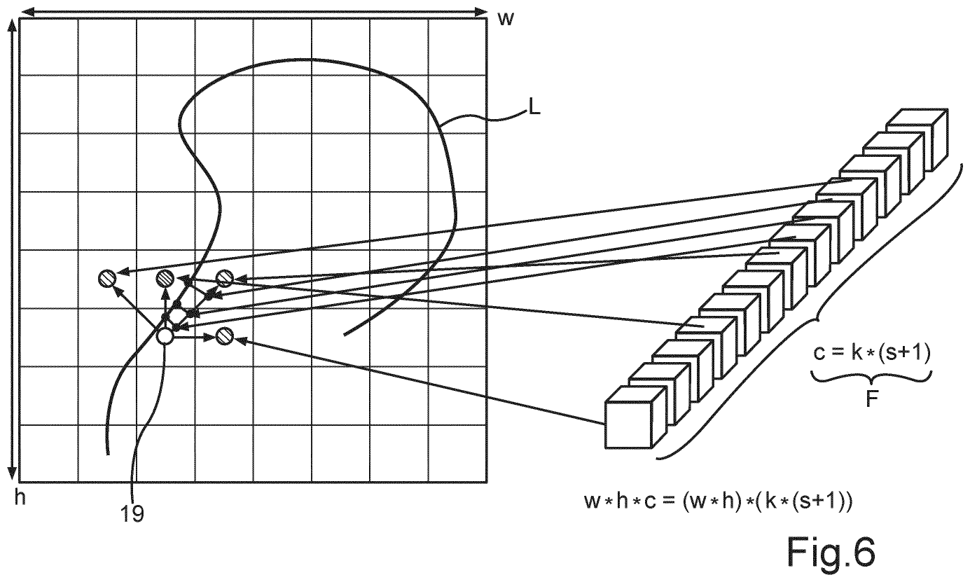

FIG. 6 shows a square grid with the dimensions w * h, wherein w can indicate the width and h the length of the square grid. A line segment L is illustrated, which is positionally shifted by way of the number of the distance values c. By the number of the distance values c, which can result from the formula F c=k*(s+1), a dimensional shift or an orthogonal shift of the line segment L to be generated can result. This means that the predefined number of offset sample values s as well as the predefined neighbor connections k can regress the orthogonal shift by way of the number of the distance values c to be calculated by the formula F to an actual polyline (to the actual object structure), wherein each image element included by the polyline (object structure) can include a regressed segment of the actual polyline. Thus, the number of the distance values c can each provide support points for the resulting line segment L. Therein, the number of the offset sample values s can be parameterized. A formula (o=w*h*c=(w*h)*(k*(s+1)) is also illustrated, by which a number of dimensions of the square grid can be calculated.

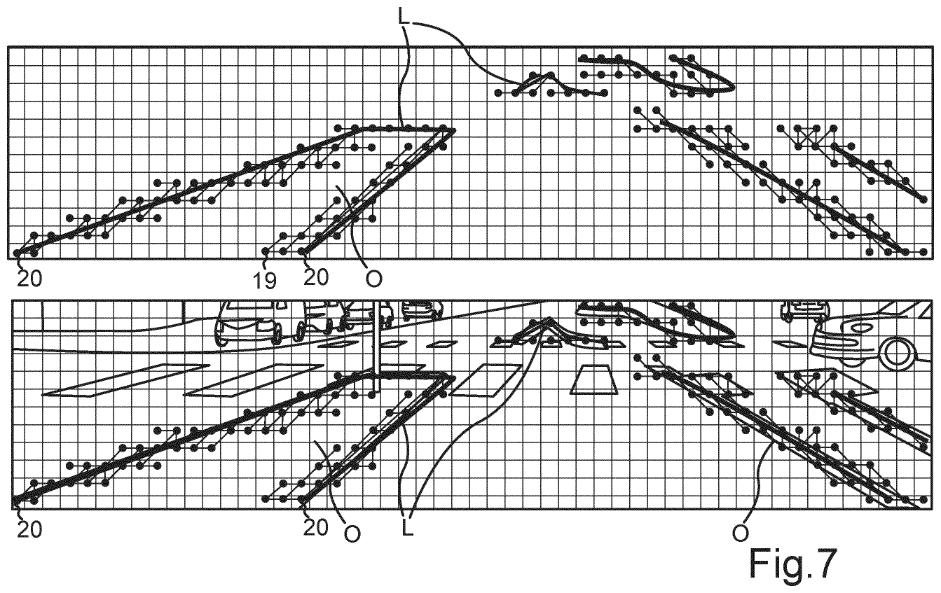

FIG. 7 shows marked line segments L after application of the graph search criterion 15, wherein the line segment L extends through a most inexpensive path. Contour end points 20 are also illustrated. Contour end points 20 can arise in that the edge intermediate points 19, which are closest to a respective edge end point 18, are marked as contour end points 20 of the object structure. More than one path between contour end points 20 can also be calculated and/or found from the graph search criterion 15. This can arise if the graph search criterion 15 attempts to find from each contour end point 20 a most inexpensive path to a further contour end point 20. In other words, the graph search criterion 15 can determine the optimum path within the graph (at least two contour end points 20, which are connected via edge intermediate points 19 adjacent in pairs). Now, this optimum path can be marked along a concatenation of contour end points 20 and contour intermediate points 19, wherefrom line segments L can result, which can describe an or at least one object structure of the object O.

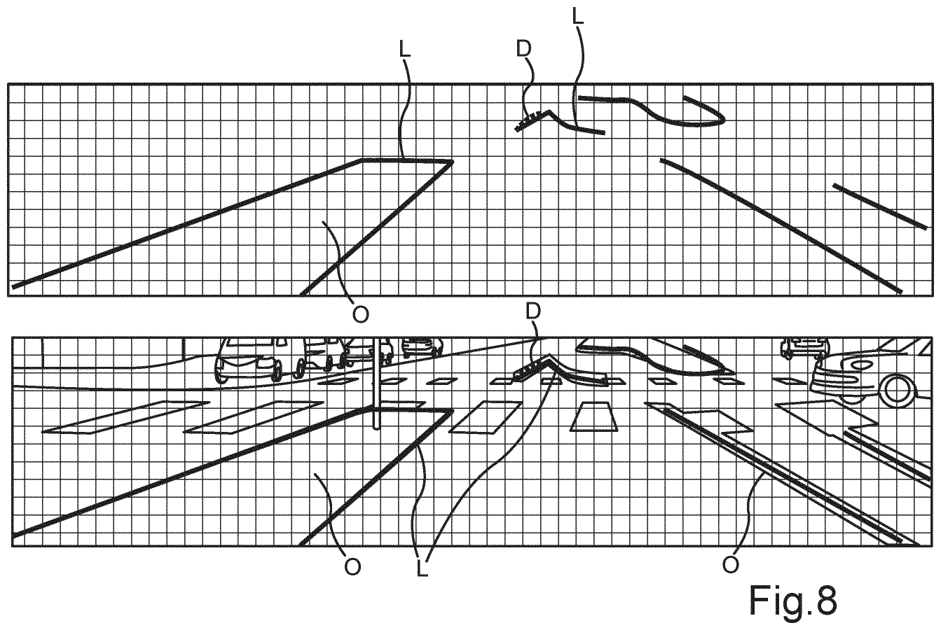

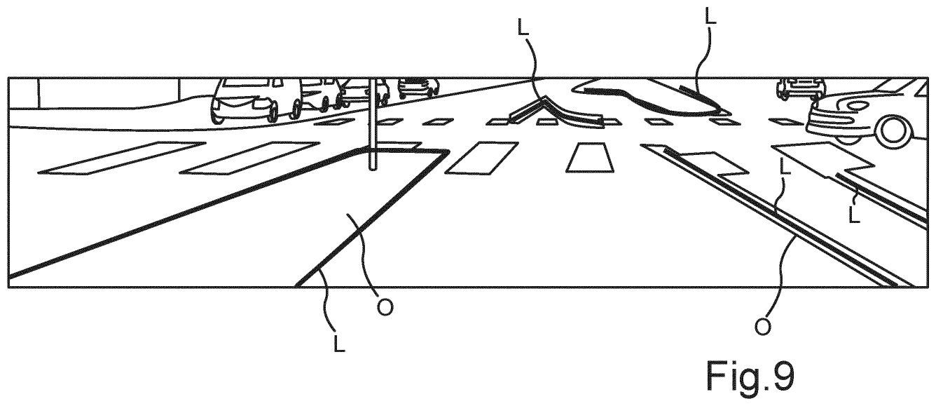

FIG. 8 shows marked line segments L (polylines), which can describe an or at least one object structure, wherein a duplicated line segment D is also marked. This duplicated line segment D is to be removed and/or deleted such that the driver assistance function can get only one polyline per object O as an input. Therefore, a deletion criterion 17 can be applied to the determined line segments L in the last step such that duplicated or replicated line segments D, which have a cost value above a predetermined threshold value, are deleted and thereby line segments L remain, which indicate the object structure of the respective object O, as is illustrated in FIG. 9. Lane markings and traffic islands or lane edges can thus be determined and be described by a polyline geometry.

By the disclosure, a method for determining polylines (object structure) of an object O as well as an object recognition algorithm (at least one neural network) can be provided, which is based on at least one neural network and/or neural convolutional network. A camera image (image data 1) can be the input. The output can be recognized objects O or an object structure of the object O in the image, which can be described, e.g., by a polyline geometry. The at least one neural network can be based on a (single-stage) recognition architecture, which can be suitable for real-time applications (e.g., autonomous driving). The at least one neural network can use two heads (two binary classifiers). The first head (edge end point determiner 8) can recognize and/or mark key points or edge end points 18 (the end points) of polyline objects (object structure) in the image. The second head (edge intermediate point determiner 9) can recognize and/or mark a connectivity graph (graph), which captures the topology of the objects in the image (image data 1). The key points and the connectivity graph can then be used for searching for polylines in an efficient post-processing step.

Overall, the examples show, how a system and a method for object recognition based on at least one neural network and/or convolutional network can be provided, wherein an input is camera images (image data 1) and an output is one or more recognized objects O and/or one or more determined object structures in the image, which are described by a polyline geometry.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for determining an object structure of an object, comprising:
receiving image data, that describes an image of an environment with the object located therein from at least one sensor device;
feeding the image data into at least one neural network, that is trained to determine feature data, wherein the feature data includes predetermined features with respect to basic geometric shapes and/or colors of the object;
determining edge end points of the object structure of the object by applying an edge end point determiner of the at least one neural network to the feature data, wherein each of the edge end points marks a predetermined object end area of the object;
determining edge intermediate points of the object structure by applying an edge intermediate point determiner of the at least one neural network to the feature data, wherein the edge intermediate points mark line geometric shapes of the object, wherein a line geometric shape is a part of the object structure of the object,
wherein the determining of the edge end points and the determining of the edge intermediate points are performed independently of each other;
determining the object structure by way of the edge end points and the edge intermediate points,
wherein the edge intermediate points that are closest to a respective edge end point, are marked as contour end points of the object structure, and at least two of the contour end points are respectively connected via edge intermediate points respectively adjacent in pairs; and
providing the object structure for a computer vision function.

2. The method according to claim 1, wherein in the determining of the object structure, at least two contour end points are connected via the edge intermediate points by way of a graph search criterion, and line segments are generated as a result thereof.

3. The method according to claim 2, wherein the line segments include a cost value, and the cost value is calculated by way of the graph search criterion.

4. The method according to claim 3, wherein the line segments that have a cost value above a predetermined threshold value are deleted by way of a deletion criterion, and the line segments that remain indicate the object structure.

5. The method according to claim 2, wherein the edge intermediate points include a predetermined number of distance values with respect to a local curvature that causes a positional shift upon generation of the line segments.

6. The method according to claim 1, wherein the feature data is determined by way of a self-attention technique.

7. The method according to claim 1, wherein the feature data is determined by way of a feature pyramid network technique.

8. The method according to claim 1, wherein the at least one neural network is trained to determine the object structure by way of a backpropagation, wherein training data is used that has a label of the object structure.

9. A control device for a system, the control device comprising:
a processor; and
a memory storing program instructions that, when executed by the processor, cause the control device to perform the method according to claim 1.

10. A system comprising:
the control device according to claim 9; and
the at least one sensor device.
